(19) United States
(12) Patent Application Publication
(10) Pub. No.: US 2011/0014490 A1
(43) Pub. Date: Jan. 20, 2011

(54) Methods for Brazing Powder Metal Parts

(75) Inventor: Fred Wolfe, Rougemont, NC (US)

Correspondence Address: KALOW & SPRINGUT LLP, 488 MADISON AVENUE, 19TH FLOOR, NEW YORK, NY, 10022, US

(73) Assignee: SCM Metal Products, Inc., Research Triangle Park, NC (US)

(21) Appl. No.: 12/503,918

(22) Filed: Jul. 16, 2009

(51) Int. Cl. B32B 5/18; B23K 1/20; B23K 31/02; B32B 15/01

(52) U.S. Cl. 428/613; 228/248.1; 228/200

(57) ABSTRACT

A method is provided for brazing porous metal parts. By heating a filler metal such as a brazing alloy containing composition to a temperature between the solidus and liquidus temperature, the brazing alloy can be caused to partially infiltrate the pores of a porous metal part. After being infiltrated, the brazing alloy containing composition may be cooled and thereby able to form a strong adhesion between the porous metal parts and another material. The other material may, for example, be a solid material or another porous metal part.

### FIELD OF THE INVENTION

The present invention relates to the field of brazing powder metal parts.

### BACKGROUND

Powder metal parts are made by pressing a metal or alloy powder in a die and then sintering the pressed parts at an appropriate temperature to achieve the desired properties, such as strength and ductility. The finished parts are usually porous, and the amount of porosity may be controlled both by the density to which the parts are pressed and by the sintering parameters used. These parameters include temperature, time at a temperature (or within a temperature range) and the furnace atmosphere.

Powder metal parts are typically pressed in a vertical direction. While the resulting parts can be quite complex in structure, one limitation of powder metal parts that is well known to persons of ordinary skill in the art is that holes and other features that are oriented in the horizontal direction cannot be pressed. Consequently, in order to obtain parts with desired shapes while working within the aforementioned limitations, two or more separate powder metal parts may be made and then joined to each other by brazing. Some applications require joining a porous powder metal part to a solid metal part instead of to another powder metal part, which also may be accomplished by brazing.

Under the technique of brazing, a substance is used to cause the two materials to become joined to each other, e.g., two powder metal parts or one powder metal part and a solid material. This substance that causes the two materials to become joined to each other is commonly referred to as a “filler metal” and may for example, comprise copper and/or copper alloys. As used herein a “filler metal” includes any metal or metal containing substance such as an alloy that may be used to join two materials together. A brazing alloy is a type of filler material that contains an alloy that can be used in brazing. The filler metal may be solid (wire, strip, or formed shape), a powder or a paste or a combination thereof. When a paste is used, the paste may be comprised of a filler metal powder suspended in a water-based or an organic solvent-based binder.

Prior to brazing, the parts to be brazed are assembled such that they are typically separated by a 0.001-0.002 inch wide gap in the joint area, which is the area at which attachment is desired. The filler metal is placed at the joint, and the assembly is heated to a temperature above the melting point of the filler metal. At this temperature, the filler metal melts and flows into the gap by e.g. capillary action thereby forming the braze joint. If the filler metal is in the form of a paste, the binder decomposes at a low temperature and escapes via the furnace exhaust duct before the filler metal melts. A braze joint is considered good if under tensile loading, the fracture occurs in one of the two materials that were joined rather than in the braze joint.

As persons of ordinary skill in the art are aware, brazing is a process that is currently widely used to join metal parts. For example, brazing of solid steel and stainless steel parts is very common in the automotive industry for applications such as torque converters, fuel system components, etc.

Unfortunately, brazing of powder metal parts as opposed to solid metal parts poses a special challenge. Because these parts are porous, the molten filler metal “infiltrates” into the pores by capillary action, thus starving the braze joint of the filler material. This phenomenon is particularly problematic for standard copper and copper alloy filler metals because they have a very low viscosity at their respective melting temperatures, and infiltrate the pores very easily, which under currently known methods makes it difficult to make a good braze joint using these filler metals.

### SUMMARY OF THE INVENTION

The present invention relates to a novel method for brazing of powder metal parts to each other or brazing a powder metal part to a solid metal part as well as to the products made by these methods. It also relates to brazing filler metal alloy compositions. The methods of the present invention, which may be referred to as “solidus-liquidus brazing,” involves brazing the parts at a suitable temperature within the “mushy zone” or the zone between the solidus and liquidus temperatures of e.g., an alloy.

The phenomenon of a “mushy zone” between a liquidus and solidus temperature is well known to persons of ordinary skill in the art. As they are aware, the liquidus temperature is the maximum temperature at which crystals of an alloy can co-exist with a melt in thermodynamic equilibrium. Above the liquidus temperature, the material is homogeneous and is composed entirely of liquid, while below the liquidus temperature, more crystals begin to form. By contrast, the solidus temperature is the point below which a material completely solidifies. When the liquidus temperature and the solidus temperature are the same, it is called the “Eutectic” temperature, and all solid material is converted to liquid when heated above the Eutectic temperature. However, when they are not the same, the material can simultaneously exist in the solid and liquid phases.

Because partial melting occurs in the mushy zone, in this temperature range the brazing alloy has some solid phase and some liquid phase. When the brazing alloy is subjected to a temperature in this range and placed in contact with a porous powder metal part, some of the liquid infiltrates into the porosity in the part(s), thus “anchoring” the braze joint to the part(s). The solid, and possibly some liquid, remain in the braze gap and form the braze joint. The proportion of liquid phase to solid phase depends on the brazing temperature; the higher the temperature the greater the amount of liquid phase. Exemplary filler materials include but are not limited to a binary copper alloy such as bronze (copper-tin), brass (copper-zinc) or copper-phosphorus alloy, or a ternary copper alloy such as copper-tin-zinc, copper-zinc-manganese, etc. Nickel, aluminum and silver base alloys can also be used for brazing different parts.

According to one embodiment, the present invention provides a method for brazing a porous metal part to a material, wherein the material comprises at least one of a powder metal part or a solid metal part. (The part does not need to be sintered prior to brazing.) The method comprises the steps of: (a) placing a filler metal in a suitable form, such as a paste, between said porous metal part and said material to form an assembly, wherein the paste comprises a brazing alloy and in the assembly the paste contacts both the porous metal part and the material; and (b) heating the assembly to a temperature between the liquidus temperature and the solidus temperature of the brazing alloy, wherein between 10 and 90 wt. % of the filler metal forms a liquid phase and at least some of said liquid phase infiltrates the porous metal part and the remaining liquid phase combines with the solid phase to form the braze joint.

According to a second embodiment, the present invention provides a method for brazing friction pads. The method comprises: (a) blending a sponge iron powder with metallic and non-metallic additives to form a friction mix; (b) pressing the friction mix into a friction pad; (c) coating a surface of the friction pad with a brazing alloy to form a coated friction pad; (d) forming an assembly comprised of the coated friction pad and a steel backing plate that has a copper plating, wherein the brazing alloy of the coated friction pad is in contact with the copper plating of the steel backing plate; (e) heating the assembly to a temperature between the solidus temperature and the liquidus temperature of the brazing alloy for a time sufficient to cause between 10 and 90 wt. % of the brazing alloy to form a liquid phase (some of which infiltrates into the friction pad) and for the balance of liquid phase and the solid phase to form the braze joint; and (f) cooling the assembly. The friction mix may for example comprise or consist of a blend of metal powders, graphite, ceramics etc. When compressed, this forms the friction pad. By way of non-limiting examples, friction pads include brake pads, clutch pads, etc.

In a third embodiment, the method of the second embodiment is followed, except that the steel backing plates are bare. In a fourth embodiment, the method of the second embodiment is followed except that a copper powder is used instead of a sponge iron powder.

The present invention teaches a novel and economic method for joining powder metal parts to other powder metal or solid metal parts. It is particularly well suited for creating brazed friction pads using copper or iron-based powders, and joining them to bare or copper plated steel backing plates. Additionally, substitution of copper-based friction pads with iron-based friction pads may provide a significant cost reduction. Moreover, the ability to join the iron-based friction pads to bare steel backing plates lends itself to even further cost reduction.

### BRIEF DESCRIPTION OF THE FIGURES

FIG. 1 is a representation of a brazed assembly using a steel friction pad and a copper plated steel backing plate (100×) according to an embodiment of the present invention.

FIG. 2 is a representation of a microstructure showing infiltration of the liquid phase into the friction pad (400×) according to an embodiment of the present invention.

FIG. 3 is a representation of a brazed assembly using a steel friction pad and a bare steel backing plate (100×) according to an embodiment of the present invention.

FIG. 4 is a representation of a microstructure showing bonding between a brazing alloy and bare steel backing plate (400×) according to an embodiment of the present invention.

FIG. 5 is a representation of a brazed assembly using a copper friction pad and a copper plated steel backing plate (100×) according to an embodiment of the present invention.

FIG. 6 is a schematic representation of a friction pad that has been brazed to a steel plate according to an embodiment of the present invention.

### DETAILED DESCRIPTION OF THE INVENTION

Through the methods of the present invention, one can braze two or more porous powder metal parts or powder metal parts and solid metal parts. According to one embodiment, the present invention provides a method comprising placing filler metal such as a brazing alloy between two materials to form an assembly, heating the assembly and cooling the assembly. The assembly thus may comprise a first material, the filler metal and a second material. The first material may be a porous metal part and the second material may also be a porous metal part. Alternatively, the second material may be a solid material that is not porous. The porous powder metal parts may typically have 10-30% porosity.

In some embodiments, a preferred brazing alloy is bronze and contains from 2 to 30 weight % tin. However, brasses containing from 2 to 30 weight % zinc, copper-phosphorus alloys containing from 3 to 10 weight % phosphorus, ternary copper alloys containing from 0.25 to 30 weight % tin and from 2 to 45 weight % zinc, copper alloys containing from 5 to 40 weight % zinc and from 5 to 30 weight % manganese, copper alloys containing from 3 to 10 weight % phosphorus and from 1 to 20 weight % silver are also useful in some embodiments. In some embodiments, the aforementioned filler materials comprise the respective components. In other embodiments, the aforementioned filler materials consist essentially of those materials, and still in other embodiments, the aforementioned filler material consist only of the recited materials. In some embodiments any unspecified ranges may be copper or copper containing materials.

The amount of liquid phase formed can be controlled by controlling the temperature and time at that temperature; the higher the temperature and the longer that the assembly is held at that temperature, the greater the amount of liquid phase. The solidus and liquidus temperatures for some common bronze, brass and copper-phosphorus alloy compositions are shown in Table I below:

TABLE I

| | | Solidus | Liquidus | Δ |
|---|---|---|---|---|
| Alloy | Composition | (° F.) | (° F.) | (° F.) |
| Bronze | 95Cu—5Sn | 1688 | 1922 | 234 |
| Bronze | 90Cu—10Sn | 1530 | 1850 | 320 |
| Bronze | 80Cu—20Sn | 1470 | 1652 | 182 |
| Brass | 90Cu—10Zn | 1904 | 1922 | 18 |
| Brass | 80Cu—20Zn | 1796 | 1832 | 36 |
| Brass | 70Cu—30Zn | 1688 | 1742 | 54 |
| Cu—P | 95Cu—5P | 1310 | 1695 | 385 |
| Cu—P | 93Cu—7P | 1310 | 1460 | 250 |

In the various embodiments of the present invention in which the filler metal is in the form of a paste, binders may be used. As persons of ordinary skill in the art are aware, binders are the vehicle or medium that holds the filler metal powder in suspension. Binders typically have water or an organic solvent as the main component, with thickeners, suspension agents, surfactants, defoamers, biocides, fluxes, etc. added to them. The amount of binder may vary from 5 to 40%. Exemplary binders include but are not limited to binders that comprise of polybutene, homopolymers of acrylic acid esters, homopolymers of methacrylic acid esters, and copolymers of acrylic acid esters and methacrylic acid esters.

In some embodiments, the filler material is bronze and contains from 80-95 wt. % copper and between 5 and 20 wt. % tin. In some embodiments, the filler material is brass and contains from 70 to 90 wt. % copper and 10-30 wt. % zinc. In some embodiments, the filler material is Cu—P and contains between 5 and 7 wt. % phosphorous and between 93 and 95% copper.

In some embodiments when bronze is used, the bronze is heated to a temperature between 1688 and 1922° F. between 1530 and 1850° F. or between 1470 and 1652° F. or between 1470 and 1922° F. In some embodiments when brass is used, the brass is heated to a temperature between 1904 and 1922° F. or between 1796 and 1832° F. or between 1688 and 1742° F. or between 1688 and 1922° F. In some embodiments, when Cu—P is used, the Cu—P is heated to a temperature between 1310 between 1695° F. or between 1310 and 1460° F. for a time sufficient to cause the desired degree of brazing.

The Δ values shown in the above table are the differences between the solidus and liquidus temperatures for the respective alloys. As is evident from the table, the Δ values for the three bronze and copper-phosphorus alloys are much larger than those for the brass alloys. This means that controlling the brazing temperature within the solidus-liquidus range is much easier for bronze and copper-phosphorus alloys than for brass. In some embodiments, bronze alloys are preferred over the brass alloys for practicing this invention with iron or copper based parts. In some embodiments, copper-phosphorus alloys are not recommended for iron based parts because they form brittle compounds. Nevertheless, they are satisfactory for brazing copper based parts.

While the present invention can be used to braze powder metal parts to other powder metal or solid parts in many applications, one particular useful application is in the friction industry. Typical examples of parts manufactured by this industry include brake pads and clutch pads for vehicles ranging from motorcycles, cars, trucks, construction vehicles (tractors, earth moving equipment, etc.), and aircraft.

One embodiment of the present invention may be applied to friction pads made out of a copper powder with additives, which include metallics (tin, nickel, etc.), and nonmetallics (graphite, oxides, sulfides, etc.)—“powder mix.” The friction pads are made by pressing the powder mix. These pads are then bonded to steel backing plates by a solid state diffusion bonding process. The friction pads and the steel plates are held close together to provide a good contact, and the assembly is heated to an elevated temperature (e.g., about 1700° F.) to form the bond. In some embodiments, it is difficult to bond the copper friction pad to a bare steel backing plate by this process. To overcome this problem, the steel backing plate may be electroplated with copper to enable formation of a bond between the copper pad and the copper plating. However, as persons of ordinary skill in the art are aware, copper plating is very expensive due to the cost of copper, the processing that is needed and the steps required to comply with environmental regulations.

The cost of the friction products can be reduced significantly by using iron powder instead of copper powder in the friction pad. In some embodiments, a sponge iron powder is preferred because the particles are porous and very irregular, and the parts have adequate green strength in the pressed condition to facilitate further handling of the parts. However, joining the iron-based friction pad to the copper plated steel backing plate by the traditional diffusion bonding process is difficult. Brazing offers a convenient way to join these parts if performed according to the teaching of the present invention.

In order to ensure that not all of the filler metal brazing alloy infiltrates the powder metal part one may control both the temperature to which the assembly is heated and the time that the assembly is subjected to the temperature that is between the liquidus temperature and the solidus temperature. In some embodiments between 10 and 90 wt. % of the brazing alloy becomes a liquid. In some embodiments, between 20 and 80 wt. % of the brazing alloy becomes a liquid. In some embodiments, between 30 and 70 wt. % of the brazing alloy becomes a liquid. In some embodiments between 40 and 60 wt. % of the brazing alloy becomes a liquid. In some embodiments, between 10 and 20 wt. % of the brazing alloy becomes a liquid. In some embodiments, between 20 and 30 wt. % of the brazing alloy becomes a liquid. In some embodiments, between 30 and 40 wt. % of the brazing alloy becomes a liquid. In some embodiments, between 40 and 50 wt. % of the brazing alloy becomes a liquid. In some embodiments, between 50 and 60 wt. % of the brazing alloy becomes a liquid. In some embodiments, between 60 and 70 wt. % of the brazing alloy becomes a liquid. In some embodiments, between 70 and 80 wt. % of the brazing alloy becomes a liquid. In some embodiments, between 80 and 90 wt. % of the brazing alloy becomes a liquid. As noted above, at the temperatures in the mushy zone, the brazing alloy forms some liquid phase and some solid phase. Some of the liquid partially infiltrates the friction pad while the solid, and in some embodiments, some of the liquid, remains behind in the braze joint.

When at least a portion of the liquid phase remains in the joint, the amount that remains in the joint will be dependent on the temperature at which the assembly is held, the time that the assembly is held at that temperature, the number of pores that are accessible and the volume of the accessible pores. In some embodiments, at least 10 wt. %, at least 20 wt. %, at least 30 wt. %, at least 40 wt. %, at least 50 wt. %, at least 60 wt. %, at least 70 wt. % or at least 80 wt. % of the liquid phase enters the pores of the metal part(s). In some embodiments, less than 90 wt. %, less than 80 wt. %, less than 70 wt. %, less than 60 wt. %, less than 50 wt. %, less than 40 wt. %, less than 30 wt. %, less than 20 wt. % of the liquid phase enters the pores of the metal part(s). When the two materials to be joined by the brazing alloy each have pores, it is understood that equal or unequal amounts of the liquid phase may enter the pores of each material, or leave the space between the two materials (the powder metal part and the second material). The braze joint thus formed is complete and strong. The partial infiltration into the friction pad anchors or locks the braze joint to the friction pad.

In a typical belt furnace, cooling is a continuation of the brazing process. The only requirements of the cooling process are that it be done in a protective atmosphere (generally same as used for brazing), and that the parts exit the furnace cool enough to avoid oxidizing them.

Brazing only requires a few minutes, e.g., in some embodiments less than 10 minutes, less than 8 minutes, less than 6 minutes, less than 4 minutes, less than 3 minutes or 2-3 minutes at temperature or within a temperature range. However, sintering is a longer process—typically 15 to 60 minutes. If the part is sintered and brazed simultaneously, the total time may for example be between 15 to 60 minutes or 20 to 50 minutes or 30 to 40 minutes. Thus, by way of a further non limiting example, when using a mesh belt furnace, in some embodiments, one may conduct a preheat phase for approximately 10-30 minutes, a high heat phase of approximately 20-40 minutes and a cooling phase of approximately 50-90 minutes.

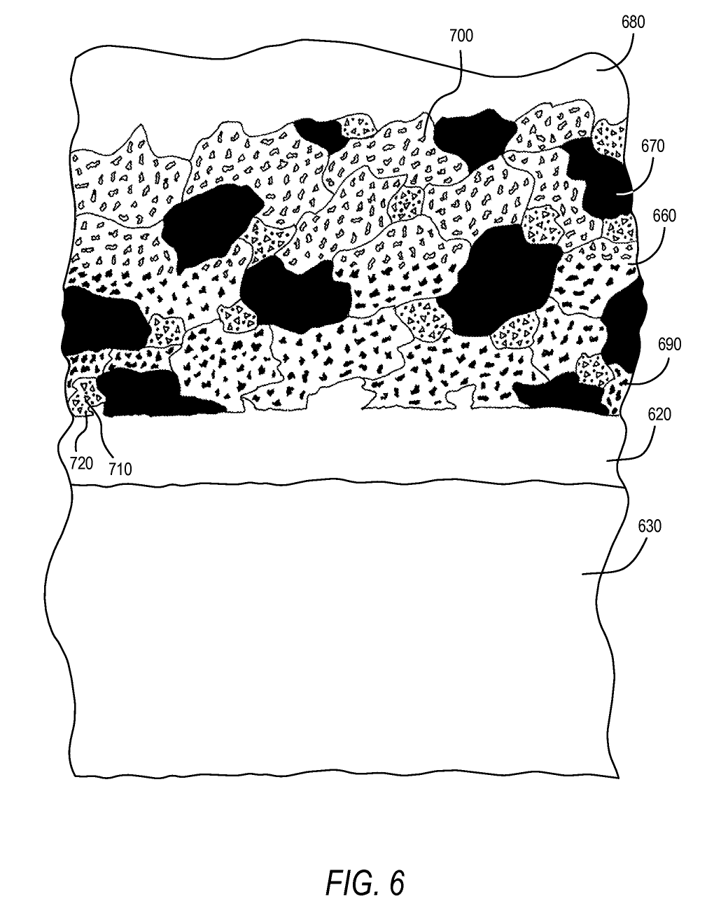

Various embodiments of the present invention may be further understood by reference to FIG. 6. FIG. 6 is a representation of the infiltrated area of one of the embodiments of the present invention. In this figure, a friction pad 680 is shown with its infiltrated area 660, adjacent to an area of the braze alloy that did not infiltrate 620 and the steel plate 630. Within the friction pad there is graphite 670, hollowed unfilled pores 700, filled pores 690, ceramic particles 710 and other additive particles 720.

If the filler metal is not part of a paste, the application technique may be different, but the sintering and brazing operations would not change. For example, if a filler metal powder is used, one could layer the friction mix and the filler metal powder on top of each other in the die and press them together as a sandwich. If the filler metal is used in the form of a foil or strip, it would be simply placed between the parts to be brazed and clamped together.

The present methods have been described with reference to the brazing alloy as part of a paste. However, in alternative embodiments the filler metal may be in the form of a strip, a wire, powder, pressed powder preform and the like.

As noted above, the methods described above may be used to form materials that comprise powder metal and solid metal parts that have been brazed. By way of example, the powder metal part may be a friction pad and the solid metal pad may be a steel backing plate. Exemplary friction pads may be made of iron powder and/or copper powder with additives to impart desired friction characteristics. Additionally, in some embodiments, the steel backing plate is copper plated.

### EXAMPLE 1

A friction mix was made by blending sponge iron powder with copper, tin, graphite, and other additives. The friction powder was pressed into standard pads. Steel backing plates were electroplated with copper. A commercial 90%-copper-10% tin prealloyed bronze powder was converted into paste using a solvent-based binder. One surface of the friction pad was coated with the brazing alloy. The pad was then assembled with the brazing alloy side in contact with the copper plating of the steel backing plate. The assembly was placed between graphite plates and clamped together. This procedure was repeated to make several assemblies.

A few friction pad assemblies were brazed in a mesh belt furnace. Twelve pads were randomly selected. The preheat zone was set at 1300° F. and the high heat zone was set at 1625° F. A reducing atmosphere containing 90% hydrogen+10% nitrogen was used in the furnace. The binder in the paste decomposed in the preheat zone and the solidus-liquidus brazing occurred in the high heat zone. The brazed assemblies were cooled to room temperature in the same reducing atmosphere. The duration of each stage was: about 20 minutes in preheat, 30 minutes in high heat and 70 minutes cooling.

The brazed assemblies were removed from the clamps. Peel tests were done on random samples of the assemblies. An exemplary test involved clamping an assembly in a vise and bending the steel backing plate away from the friction pad. In all cases, the fracture occurred in the friction pad while the braze joint maintained its integrity, indicating a strong joint.

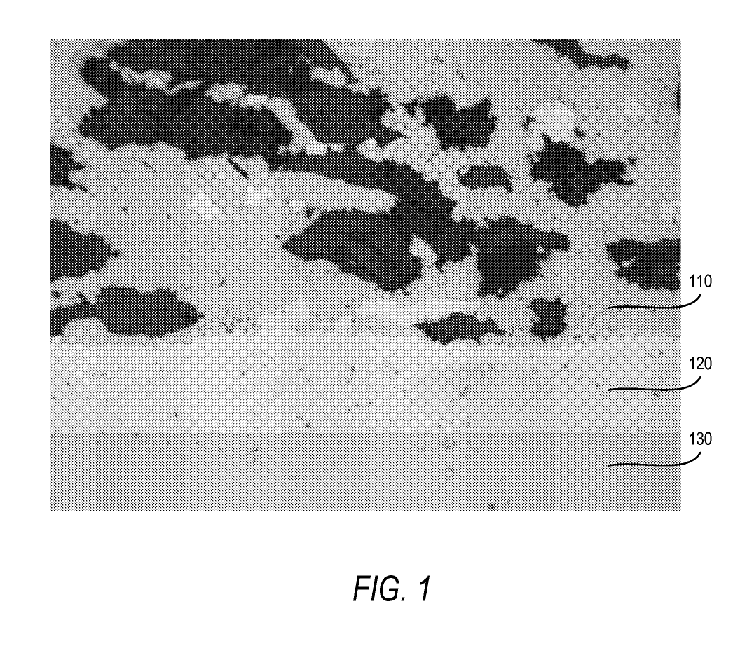

Some brazed assemblies were cut through the cross section and mounted in a hardened resin mount. These were polished and examined under a microscope. FIG. 1 shows the microstructure of the area around the braze joint

FIG. 1 shows that both the steel friction pad 110 and the copper plated steel base 120 are bonded very well to the brazing alloy 120. The dark areas in the steel friction pad are the friction additives. The copper plating on the steel plate is not readily visible because it is completely assimilated in the brazing alloy. This is a clear indication of the excellent bonding between the two.

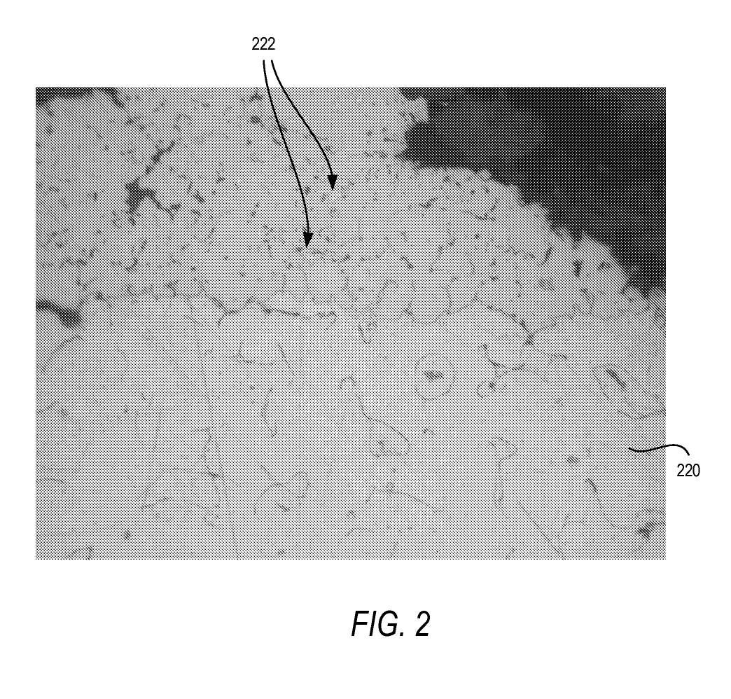

FIG. 2 shows a high magnification photo taken near the interface between the friction pad and the brazing alloy. As mentioned previously, at the brazing temperature the brazing alloy forms a liquid phase and a solid phase. At least some of the liquid phase infiltrates the pores within the iron powder particles and between adjacent iron particles. The photo shows the infiltration of the liquid phase of the braze alloy into the friction pad 222, which helps to anchor the pad to the brazing alloy 220. The solid phase, and possibly some of the liquid phase, form the bulk of the braze joint.

The cost can be reduced if one joins iron-based friction pads directly to bare steel backing plates without having to copper plate the steel. Using the process of this invention, excellent braze joints between the iron-based friction pads and bare (unplated) steel plates were made as shown in Example 2 below.

### EXAMPLE 2

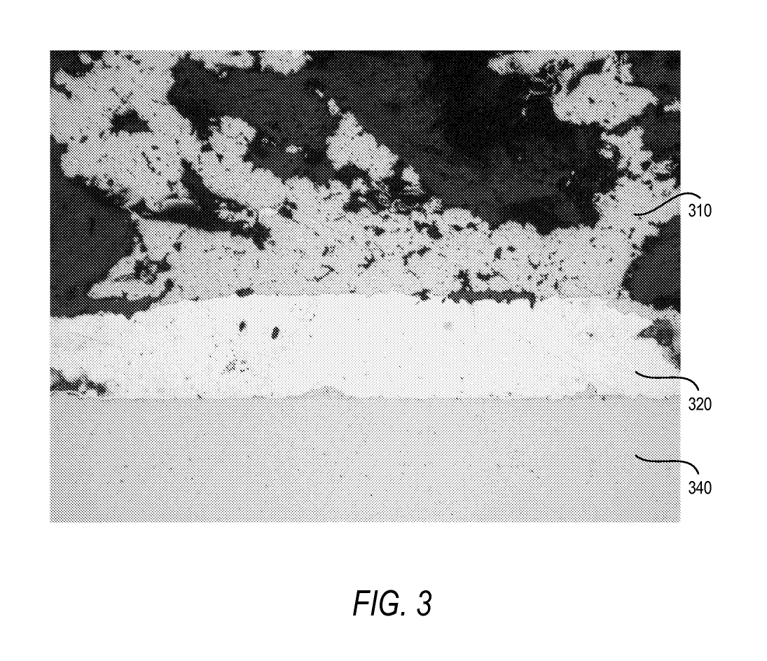

Several brazed friction pad assemblies were made using the procedure described in Example 1, except that this time the steel backing plates were bare (not copper plated). The brazed assemblies were subjected to the same peel tests, and all of them fractured through the friction pads indicating excellent integrity in the braze joints. Some pads were cut through the cross section and examined under a microscope. FIG. 3 is the microstructure of the braze joint area showing excellent bonding between the three components: the steel friction pad 310, the braze alloy 320, and the bare steel plate, 340.

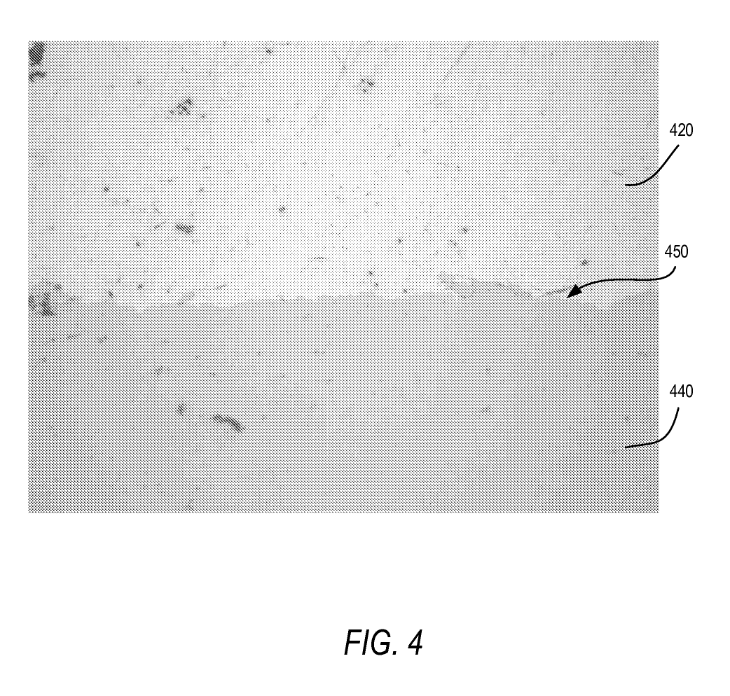

A section of the braze joint was examined at a high magnification. FIG. 4 shows the interface 450 between the brazing alloy 420 and the steel backing plate 440 indicating excellent bonding between the two.

While iron-based friction pads offer a cost advantage, copper-based friction pads still make up the major portion of the total market because of their superior corrosion resistance in salt environment. The brazing method of this invention offers an alternative to the traditional diffusion bonding process to join the copper-based friction pads to the backing plates. Example 3 demonstrates the efficacy of the brazing process.

### EXAMPLE 3

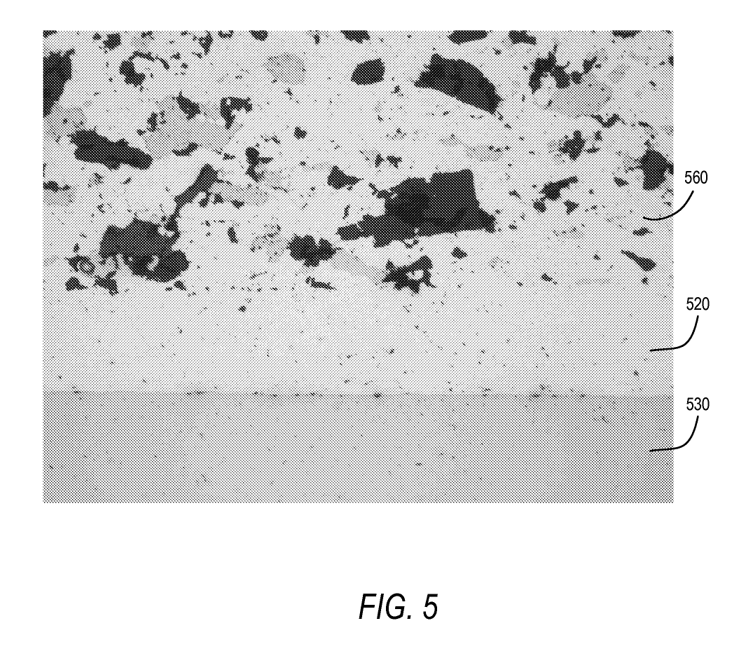

Brazed friction pad assemblies were made using the procedure of Example 1, except in this case a copper powder was substituted for the sponge iron powder. Some of the assemblies were peel tested, and again the fractures occurred through the friction pads indicating excellent braze joint integrity. Microscopic examination of the cross section was done. FIG. 5 shows the braze joint area showing excellent bonding between the three components: the copper friction pad 560, the braze alloy 520 and the copper plated steel base 530.

This application discusses specific embodiments of the present invention. The specific features described herein may be used in some embodiments, but not in others, without departing from the spirit and scope of the invention as set forth in the foregoing disclosure. Further, these examples are non-limiting, and it will be appreciated by those of ordinary skill in the art that the illustrative examples do not define the metes and bounds of the invention.

What is claimed is:

1. A method for brazing a porous metal part to a material, wherein said material comprises at least one of a powder metal part or a solid metal part, said method comprising:
(a) placing a filler metal between said porous metal part and said material to form an assembly, wherein said filler metal comprises a brazing alloy and in said assembly the filler metal contacts both said porous metal part and said material; and
(b) heating the assembly to a temperature between a liquidus temperature and a solidus temperature of the brazing alloy, wherein between 10 and 90 wt. % of the paste forms a liquid phase and at least some of said liquid phase infiltrates the porous metal part, and the remaining liquid phase combines with the solid phase to form the braze joint.

2. The method according to claim 1, further comprising after (b) cooling the assembly to a temperature at which the brazing alloy solidifies.

3. The method according to claim 1, wherein at least part of the liquid phase does not infiltrate the porous metal part.

4. The method according to claim 1, wherein the powder metal part is a friction pad and the material is a solid metal part that is a steel backing plate.

5. The method according to claim 4, wherein the friction pad is made of iron powder with metallic and nonmetallic additives.

6. The method according to claim 4, wherein the friction pad is made of copper powder with metallic and nonmetallic additives.

7. The method according to claim 4, wherein the steel backing plate is copper plated.

8. The method according to claim 1, wherein the filler metal is part of a paste and the paste further comprises a water-based or an organic solvent-based binder.

9. The method according to claim 1, wherein the brazing alloy of claim 1 comprises copper and 2 to 30 weight % tin.

10. The method according to claim 1, wherein the brazing alloy comprises copper and 2 to 30 weight % zinc.

11. The method according to claim 1, wherein the brazing alloy comprises copper and 3 to 10 weight % phosphorus.

12. The method according to claim 1, wherein the brazing alloy comprises copper, 0.25 to 30 weight % tin, and 2 to 45 weight % zinc.

13. The method according to claim 1, wherein the brazing alloy comprises copper, 5 to 40 weight % zinc, and 5 to 30 weight % manganese.

14. The method according to claim 1, wherein the brazing alloy comprises copper and 3 to 10 weight % phosphorus and 1 to 20 weight % silver.

15. The method according to claim 1, wherein between 30 and 70 weight % of the paste forms said liquid phase.

16. The method according to claim 15, wherein less than 60 weight % of the liquid phase infiltrates the porous metal part.

17. A method for brazing a friction pad, said method comprising:
(a) blending a sponge iron powder with metallic and nonmetallic additives to form a friction mix;
(b) pressing the friction mix into a friction pad;
(c) coating a surface of the friction pad with a brazing alloy to form a coated friction pad;
(d) forming an assembly comprised of the coated friction pad and a steel backing plate that has a copper plating, wherein the brazing alloy of the coated friction pad is in contact with the copper plating of the steel backing plate;
(e) heating the assembly to a temperature between a solidus temperature and a liquidus temperature of the brazing alloy for a time sufficient to cause between 10 and 90 wt. % of the brazing alloy to form a liquid phase; and
(f) cooling the assembly.

18. A method for brazing friction pads, said method comprising:
(a) blending a copper powder with metallic and nonmetallic additives to form a friction mix;
(b) pressing the friction mix into a friction pad;
(c) coating a surface of the friction pad with a brazing alloy to form a coated friction pad;
(d) forming an assembly comprised of the coated friction pad and a steel backing plate that has a copper plating, wherein the brazing alloy of the coated friction pad is in contact with the copper plating of the steel backing plate;
(e) heating the assembly to a temperature between a solidus temperature and a liquidus temperature of the brazing alloy for a time sufficient to cause between 10 and 90 wt. % of the brazing alloy to form a liquid phase; and
(f) cooling the assembly.

19. An assembly produced according to the method of claim 1.

20. An assembly produced according to the method of claim 17.
